(19) United States
(12) Patent Application Publication
(10) Pub. No.: US 2007/0069428 A1
(43) Pub. Date: Mar. 29, 2007

(54) Ultrasonic scoring for a web

(75) Inventors: Michael R. Pfaff, Rochester Hills, MI (US); John B. Howard, Wildwood, MO (US)

Correspondence Address: FOLEY AND LARDNER LLP;SUITE 500, 3000 K STREET NW, WASHINGTON, DC, 20007, US

(73) Assignee: Delaware Capital Formation, Inc.

(21) Appl. No.: 11/520,057

(22) Filed: Sep. 13, 2006

Related U.S. Application Data
(60) Provisional application No. 60/716,083, filed on Sep. 13, 2005.

(51) Int. Cl. B06B 1/02

(52) U.S. Cl. 264/442

(57) ABSTRACT

An apparatus, method, in-line press, and cassette for conditioning a substrate for subsequent processing, the apparatus comprising: an ultrasonic energy device with an ultrasonic horn having a contact surface; a rotatable cylinder having a raised profile with a linear or curvilinear pattern, the rotatable cylinder disposed adjacent the horn, but on an opposite side from the substrate; wherein the substrate is squeezed between the contact surface of the ultrasonic horn and the pattern on the rotatable cylinder to thereby apply heat and pressure during operation of the ultrasonic energy device to create a linear or curvilinear indentation in a surface of the substrate.

### CROSS-REFERENCE TO RELATED PATENT APPLICATIONS

This application claims priority from U.S. Provisional Application 60/716,083, filed Sep. 13, 2005, incorporated herein by reference in its entirety.

### DESCRIPTION OF THE RELATED ART

In the manufacture of completed cartons there is a serious bottleneck in the finishing process where blanks are creased, or scored, so they can be subsequently folded to form the cartons. This creasing must be done in a very slow, secondary operation, which severely limits the throughput of cartons. This is a particular problem for plastic cartons. There is also a similar bottleneck in embossing and curing applications.

### SUMMARY OF THE INVENTION

In one embodiment, an apparatus is disclosed for conditioning a substrate for subsequent processing, comprising: an ultrasonic energy device with an ultrasonic horn having a contact surface; a rotatable cylinder having a raised profile with a linear or curvilinear pattern, the rotatable cylinder disposed adjacent the horn, but on an opposite side from the substrate; wherein the substrate is squeezed between the contact surface of the ultrasonic horn and the pattern on the rotatable cylinder to thereby apply heat and pressure during operation of the ultrasonic energy device to create a linear or curvilinear indentation in a surface of the substrate.

In a further embodiment, a conditioning method is disclosed, comprising: receiving a substrate having a surface to be indented; applying wave energy and at substantially the same time applying a squeezing pressure along a narrow substantially linear or curvilinear area of the surface of the substrate, wherein the wave energy is sufficient to heat the surface in this narrow substantially linear or curvilinear area to create a reduced thickness therein.

In a yet further embodiment, a cassette is disclosed, comprising: a support frame; within the support frame, structure for supporting a substrate path for receiving a substrate of material; an ultrasonic horn; a rotatable cylinder having a raised profile with a linear or curvilinear pattern, the rotatable cylinder disposed adjacent the ultrasonic horn; wherein the substrate is squeezed between the contact surface of the ultrasonic horn and the pattern on the rotatable cylinder to thereby apply heat and pressure to create a linear or curvilinear indentation in a surface of the substrate.

In yet a further embodiment, a carton creation method is disclosed, comprising: receiving a web having a surface to be indented; applying wave energy and at substantially the same time applying a squeezing pressure along a narrow substantially linear or curvilinear area of the surface of the web, wherein the wave energy is sufficient to heat the surface in this narrow substantially linear or curvilinear area to create a reduced thickness therein; and cutting the web.

In yet a further embodiment, an in-line press is disclosed, comprising: a printing station; an indenting station comprising a support frame, within the support frame structure for supporting a substrate path for receiving a substrate, a wave energy generator with a wave energy applicator for generating and applying wave energy to the substrate, a rotatable cylinder having a raised profile with a linear or curvilinear pattern, the rotable cylinder disposed on an opposite side of the substrate path from the wave energy applicator and substantially directly opposite to the wave energy applicator, and; a rotary diecutting station.

### BRIEF DESCRIPTION OF THE DRAWINGS

FIG. 1 is a schematic diagram of one embodiment of the invention.

FIG. 2 is a diagram for illustration purposes only of a carton web after a indentation step has been performed.

FIG. 3 is a schematic diagram of one embodiment of a indentation station according to the present invention.

FIG. 4 is a cross-sectional view of a indentation roll in combination with a wave device according to one embodiment of the invention.

### DETAILED DESCRIPTION OF THE PREFERRED EMBODIMENTS

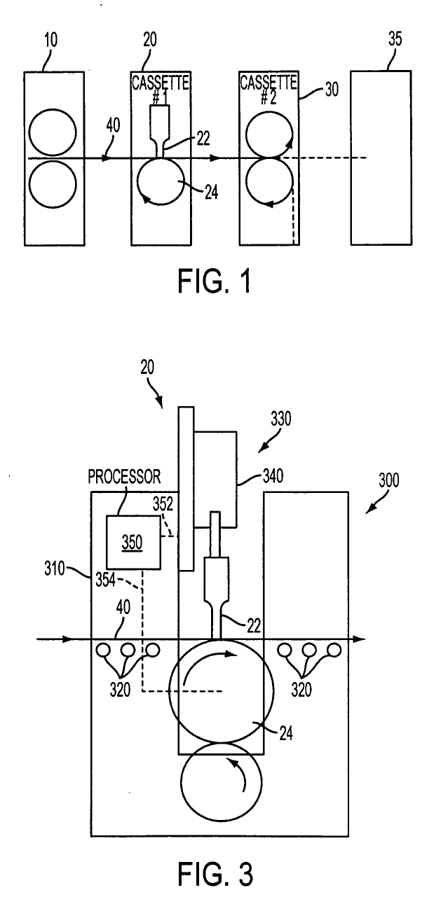

Referring to FIG. 1, an embodiment of an in-line press is shown for creating a carton. In one embodiment, the in-line press may be comprised of modular stations in the form of cassettes that may be moved into and out of the in-line press in dependence on the job to be processed. Note that the invention is not limited to a modular construction, but such construction is provided for illustrative purposes. The in-line press comprises in one embodiment one or more in-line printing stations 10 for providing printing on a substrate 40, and a wave energy indentation station 20 for creating a linear or curvilinear indentation in the substrate. By way of example, the substrate may be a sheet or a web. The material of the substrate is not limiting on the invention and, for example, may be plastic, or paper, coated paper, or metal such as metal foil.

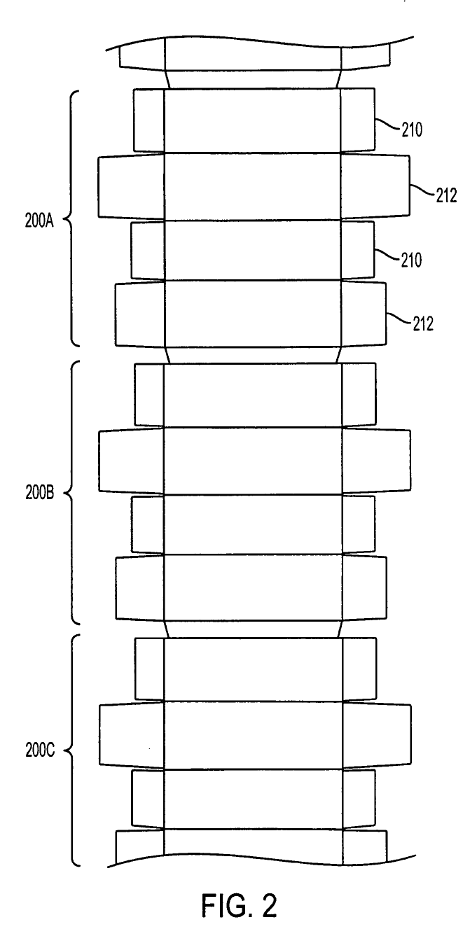

In the embodiment shown in FIG. 1, the substrate is a web 40. The in-line press further may include a rotary diecutting station 30, for processing the web 40. Note that the indentation station 20 and the diecutting station 30 may be combined into a single modular cassette. In one embodiment, the cut web resulting from the diecutting operation may then be folded along the indentation made by the indentation station 20 to form a carton. This following folding process may take place in an in-line line station 35, or in an off-line station, or at another location. A composite drawing of a web after the cutting and indentation steps have been performed is shown for illustration purposes only, in FIG. 2. Note that FIG. 2 is provided to express a concept only, because in most embodiments, not only will the vertical cuts be performed to form the carton tabs 210 and 212 or the individual cartons 200A-200C, but also cuts may be made at substantially the same time to separate each individual carton 200A-200C

As noted, in selected embodiments a problem arises where a folding step is to occur at some point in the processing. This problem is particularly notable where plastic webs, such as PVC or APET or PP are to be folded to form a carton or other item. The present invention provides a wave energy indentation station 20 to condition the substrate for subsequent processing by applying wave energy across a narrow substantially linear or curvilinear area of the web path and at substantially the same time applying pressure to this narrow linear or curvilinear area. In one embodiment, the wave energy indentation station comprises a wave energy device with a wave energy applicator 22 having a contact surface. A pressure applicator 24 is provided having a raised profile with a linear or curvilinear pattern, the pressure applicator 24 is disposed adjacent the wave energy applicator, but on an opposite side of the substrate 40 from the wave energy applicator 22.

This embodiment further comprises a displacement structure for moving the substrate 40 between the contact surface of the wave energy applicator and the pressure applicator 24, wherein the substrate is squeezed between the contact surface of the wave energy applicator 22 and the pattern on the raised profile of the pressure applicator 24 to thereby apply heat and pressure during operation of the wave energy applicator to create a linear or curvilinear indentation in a surface of the substrate. When the wave energy applicator 22 touches the surface of the substrate 40, the wave energy is applied to the substrate. It is the inventors' understanding that the indentation in this embodiment is caused by creating a thermal rise in temperature in the substrate 40 via the absorption of mechanical vibrations of the wave energy by the substrate in combination with an application of pressure along the linear or curvilinear area that is to be indented. In the case of a plastic substrate, the plastic plasticizes locally along the linear or curvilinear area and indents under pressure. The oscillations of the wave energy applicator may be horizontal or vertical or an angle in between.

The technique to generate heat using wave energy in one embodiment is as follows. The wave energy applicator 22 comes in contact with the substrate 40 and pushes against the pressure applicator/energy director 24. In one embodiment, the wave energy applicator 22 makes the substrate vibrate at a very high frequency in a direction perpendicular to a bottom face of the wave energy applicator. Since a bottom side of the substrate 40 (the side opposite to the substrate surface in contact with the wave energy applicator) is in contact with the pressure applicator 24, the substrate surface is rapidly rubbed against the surface of the pressure applicator 24. This rubbing causes friction and the substrate 40 begins to melt and deform roughly to the shape of the surface of the pressure applicator 24.

Note that the wave energy applicator 22, the substrate item 40 and the pressure applicator 24 should to be tuned as a system. The reason it is preferred that all three elements are tuned as a system lies in the friction aspect of heat generation. The pressure applicator/energy director 24 allows the substrate to efficiently convert the vibratory energy induced by the wave energy applicator 22 into heat. If the pressure applicator 24 is not tuned well enough to allow the conversion of vibratory energy to heat, poor conversion efficiency can result. In the worst case, the energy director could vibrate 180 degrees out of phase with the frequency of the ultrasonic horn, so that minimal heating of the substrate would occur.

In one embodiment, the wave energy is ultrasonic energy, the wave generator is an ultrasonic generator and the wave energy applicator 22 is an ultrasonic horn. The term “horn” is to be interpreted broadly as any device that applies wave energy to a substrate. Although not limiting on the invention, in one embodiment, the wavelength used may be 20,000 cycles for a web of plastic. Note that other frequencies may be used, depending on the material of the web or the type or thickness or other characteristic of the web material or job.

Note that the location of the displacement structure is not limiting on the invention, and can be part of a cassette that includes the indentation station 20, or can be located at another station either upstream or downstream from the indentation station 20.

It should be noted for purposes of this patent and for the claims, that the term “indentation” means that minimal or no cutting is taking place using the wave energy, but rather that a crease is formed in the web by heating and displacing and/or compressing the material of the web 40. In one embodiment, the web in this area is heated to a temperature sufficient to melt or plastize the web along a narrow substantially linear or curvilinear area.

In one embodiment, that portion of the substrate 40 that is to be indented may be moved toward a gap between the wave energy applicator 22 that applies the wave energy and a pressure applicator 24 that applies pressure to an opposite side of the substrate to press the substrate 40 against the wave energy applicator as it moves into a gap therebetween. For a plastic web 40, as the portion of the web 40 to be indented moves into the gap between the wave energy applicator 22 and the pressure applicator 24, and the wave energy applicator 22 touches the substrate, wave energy is applied on the narrow substantially linear or curvilinear area that is to have the indentation formed therein.

Referring now to FIG. 3, an embodiment of a modular cassette for a station 20 that includes a indentation operation is shown. In this embodiment, the station 20 comprises a support frame 310. Structure 320 is provided on the support frame 310 for creating a web path for receiving a web 40 of material. Although not limiting on the invention, in one embodiment, this structure 320 may comprises a set of rollers 320. The indentation station 300 further comprises a wave generator 330, which in one embodiment, may comprise a wave amplifier and controller 340 and a wave horn 22 for applying the wave energy. Note that in one embodiment, the wave generator may comprise an ultrasonic generator, such as the 2000W CS Ultrasonic Generator made by Hermann Ultrasonics, Inc. of Schaumberg, Ill., that includes an ultrasonic stack comprising a 4000W CS converter with a 1:2 amplitude coupler and a 161 mm horn 22.

In one embodiment, the pattern for the indentation may be obtained by using a pressure applicator 24 that is a rotatable cylinder having a raised profile with a linear or curvilinear pattern. Such a rotatable cylinder may be formed, for example, using a solid metal roll, or by using an anvil over which a sheet metal or other material pattern is disposed. As noted above, the wave energy applied to the substrate at the location of the desired indentation must be sufficient to heat the web in this narrow area to create an indentation. This application of sufficient energy may be accomplished by adjusting the level of the energy generated by the wave energy generator 330, and/or by varying a pressure at which the contact surface of the wave energy applicator 22 contacts the web 40, and/or by varying the length of time during which the contact takes place, or in any other convenient manner.

A displacement structure 320 is also provided for moving the substrate into the gap between the wave energy applicator 22 and the rotatable cylinder 24. The location of the displacement structure is not limiting on the invention. For example, the displacement structure may comprise rollers 320 on either or both sides of the rotatable cylinder 24. One or more of these rollers may be driven. Alternatively, the rotatable cylinder 24 may be driven. Alternatively, some other mechanism may be used to cause relative movement between the substrate and the gap between the wave energy applicator 22 and the rotatable cylinder 24. Note that the displacement structure may be part of a cassette for the indentation station or may be in another convenient station. Also, note that the relative speed of the substrate or machine cycle may be independent of the rotation speed of the rotatable cylinder

The relative movement of the substrate 40 into the gap between the wave energy applicator 22 and the rotatable cylinder 24 may have a number of permutations. For example, the substrate 24 could be moved into the gap normal to an axis of rotation of the rotatable cylinder 24. Associative to this configuration, the raised element or profile on the rotatable cylinder may be disposed parallel to the axis of rotation of the rotatable cylinder, normal to the axis of rotation of the rotatable cylinder 24, or at any angle in between. Alternatively, the substrate could be moved in a manner such that the rotatable cylinder is not normal, i.e., the rotatable cylinder is skewed to the normal of the direction of movement of the substrate. Associative to this, the raised element or elements that form the raised profile may be disposed parallel to the axis of rotation of the rotatable cylinder 24, normal to the axis of rotation of the rotatable cylinder, or at any angle in between. As noted previously, for any of these permutations, the substrate could be either a sheet or a continuous web.

Accordingly, in one embodiment, the displacement structure may displace the substrate in a direction substantially normal to an axis of rotation of the rotatable cylinder 24, wherein the raised profile with the linear or curvilinear pattern of the rotatable cylinder is substantially parallel to the axis of rotation of the rotatable cylinder. Alternatively, the displacement structure may displace the substrate in a direction substantially normal to an axis of rotation of the rotatable cylinder and wherein the raised profile with the linear or curvilinear pattern of the rotatable cylinder is not substantially parallel to the axis of rotation of the rotatable cylinder. Alternatively, the rotatable cylinder may not be disposed substantially normal to a direction of movement of the substrate, and the raised profile with the linear or curvilinear pattern of the rotatable cylinder may not be substantially parallel to the axis of rotation of the rotatable cylinder. Alternatively, the rotatable cylinder may not be substantially normal to a direction of movement of the substrate, and the raised profile with the linear or curvilinear pattern on the rotatable cylinder may be disposed substantially parallel to the axis of rotation of the rotatable cylinder.

The patterned rotatable cylinder 24 is defined for this patent to be a cylinder with one or more elements projecting from the cylinder surface to realize a raised profile. The patterned rotatable cylinder 24 is disposed on an opposite side of the web path from the wave energy applicator 22 of the wave generator 330 and substantially directly opposite to the wave energy applicator 22 to form a gap into which the substrate is moved. Note that the shape of the patterned element or elements for raising the profile of the rotatable cylinder may be used to increase or decrease the application of wave energy to the web where it touches the web. For example, the height of the element or elements may be increased to increase the contact pressure of the wave energy applicator 22 to the substrate in the selected narrow substantially linear or curvilinear area. Alternatively, the width of the top surface of the element or elements may be increased to increase the length of time during which the pressure is applied to the substrate in this area.

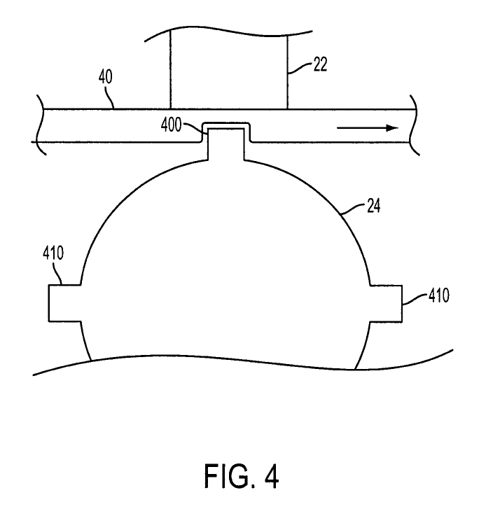

Referring to FIG. 4, a close-up view is shown of one embodiment of an area where the indentation operation is performed. In this embodiment, it can be seen that the elements 410 on the rotatable cylinder 24 are pressed/squeezed into the bottom of the substrate 40, but the wave energy applicator 22 does not actually cut or remove material from the web. Rather, the wave energy applied by the wave energy applicator 22 applies the wave energy to heat the web at this location via friction or other means, which in one embodiment, may cause deformation 400 of the substrate 40 in this narrow area. Thus, the substrate is squeezed between the contact surface of the wave energy applicator 22 and the pattern on the rotatable cylinder 24 to thereby apply heat and pressure to create a linear or curvilinear indentation in a surface of the substrate. Accordingly, the heat causes the substrate to yield thereby displacing some of the thickness to areas adjacent to the indentation, thereby reducing the thickness and bend strength of the indentation relative to the unindented material. When folded, the material naturally folds along the indentation.

Note that in one embodiment of the indentation station 20, a gap sensor system and microgap controller may be used to obtain a constant programmable gap between the horn 22 and the roll 24 and/or to adjust the clearance. Such a gap controller may be used to provide compensation for thermal expansion or to adjust for substrate material differences. For example, a Hermann Ultrasonics Gap Sensor System part no. 010 206 and a Hermann Ultrasonics Microgap Controller Quad part no. 063 074 (or part no. 063 034) may be utilized. An ultrasonic generator that may be utilized to implement the present invention comprises Hermann Ultrasonics part no. 005 786, which has a peak power output of 2000 watts at a frequency of 20 kHz using a supply voltage of 230V, 3 phase, Y 60 Hz. The height adjustment of 4 mm (0.16 inches) may be used.

The configuration of the rotatable cylinder 24 is not limiting on the invention, and may take a variety of configurations. For example, the indentation roll 24 shown in partial view on FIG. 4 has three elements 410 illustrated, with a fourth element not shown. The number of elements 410 is variable, and may depend on a number of factors including the dimensions of the substrate and/or carton to be formed. The height and shape of the element or elements 410 for providing the raised profile are also not limiting on the invention. For example, the elements could have a pointed shape, or a square shape, or a rounded shape, or have a shape with a compound angle. Additionally, the height of the scoring element 410 may vary based on empirical data, and could for example, vary based on whether the indentation is to be made perpendicular to the direction of movement of the web 40 or in the same direction as the movement of the web. Thus, distinct profile heights can be used to provide distinct indentation pressures which result in distinct indentation results. Also, the width of the element 410 may be varied.

In one embodiment, the wave energy generator, wave energy applicator 22 and patterned rotatable cylinder 24 may be formed in their own modular indentation cassette or may be added to the cassette of another module such as a diecutter module. The cassette in one embodiment could be rolled into place in an in-line press or other production line via tracks in the press line and screwed or otherwise locked into place on the line. The drive mechanism, if disposed in the cassette, whether in the patterned rotatable cylinder 24 or in another roll in the cassette, would then be engaged with a drive mechanism in the in-line press to cooperatively displace the substrate through the modular station. Note that in one embodiment of the invention, an existing modular press for handling paper webs may be easily modified to process plastic or other substrate material by adding an indentation cassette with an ultrasonic or other wave energy applicator, or alternatively by substituting a diecutter cassette with such wave energy applicator and pressure applicator added thereto.

In one embodiment, a programmed processor 350 (see FIG. 3) or other control device 350 may be included to provide automatic process control for the process. For example, the control device could utilize an algorithm to control at least one of the ultrasonic energy applied to the surface of the substrate, a squeezing pressure applied to the substrate along the linear or curvilinear area, or an angular velocity of the substrate, in response to a parameter. In one embodiment, the parameter is a depth of the indentation in the substrate, that may be provided as a feedback signal by a measurement device (not shown) disposed after the gap. In a further embodiment, the parameter is a substrate material characteristic, such as a coefficient of friction of the material surface, or a material density, or other characteristic. In a yet further embodiment, the parameter is a width of the indentation in the substrate that may be provided as a feedback signal by a measurement device (not shown) disposed after the gap. The line 352 from the control device 350 controls a parameter relating to the wave energy applicator 22. For example, the signal on line 352 could be used to control an amount of energy applied to the wave energy applicator 22. Alternatively or in addition, the signal on line 352 could be used to control a position of the wave energy applicator to change the gap between the contact surface of the wave energy applicator 22 and the rotatable cylinder 24. Likewise, a line 354 from the control device 350 may be used to control a position of the rotatable cylinder 24 to change the gap between the contact surface of the wave energy applicator 22 and the rotatable cylinder 24. Alternatively or in addition, the signal on line 354 may be used to adjust an angular velocity of the substrate moving through the gap. Thus, in one embodiment where the substrate is plastic, a process control algorithm may be used which outputs a control signal to vary an ultrasonic energy level signal, and/or a pressure between ultrasonic device and rotatable cylinder, and/or a rotatable cylinder angular velocity in response to inputs of a plastic substrate specification, a rate of substrate displacement, and/or indentation target specifications. In one embodiment, the process control algorithm used for the control device may differentially adjust the angular velocity of the rotatable cylinder relative to the substrate displacement so as to modify an indented pattern length. Slowing the rotatable cylinder allows more substrate to pass by the rotatable cylinder thus lengthening the pattern and vice versa.

In one embodiment, the apparatus may further comprise a tool for disposing a chemical on at least a portion of the surface of the substrate for changing a parameter of the surface of the substrate. For example, the parameter may be a coefficient of friction of the surface of the substrate. As another example, the parameter may be a heat absorption characteristic of the substrate. As a further example, the chemical may be a conductive ink In one embodiment, the chemical may be printed on the substrate in a pattern coinciding with the raised profile of the linear and/or curvilinear pattern of the rotatable cylinder. The chemical for example, could be selected to reduce the ultrasonic energy level required to achieve a proper indentation at a given speed and pressure. Alternately, speeds could be increased or pressures reduced due to the use of the chemical. The printed chemical could change the substrate characteristics, for example, a modulus relationship to heat, to thereby make harder-to-indent materials easier to indent.

Further tests are to be performed on PVC, PP, and APET sheet substrates 40 having a thickness of approximately (0.011-0135 inches) with a maximum pattern height of 1.016 mm (0.04 inches). In tests run to-date, the indentation station operated to provide an indentation sufficient to allow a manual fold along the indentation line in all of the materials tested, when line speeds of 30 feet per minute, 100 feet per minute, and 200 feet per minute, using a power draw of 400W-700W were used to apply the indentation. However, the appearance of the material in a crease line after the indentation operation and fold operation was judged to be better in some plastic materials rather than others. In particular, the indentation operation followed by a fold operation on a PP web resulted in a white discoloration along the crease line, which was not desirable. In contrast, the test results for PVC, judged based on discoloration, were determined to be positive, and particularly positive for APET for indentation lines in the web movement direction. However, indentation lines in the across or perpendicular direction to the web path showed a tendency to break easily, rather than creating a smooth fold, so that optimization of the raised profile will need to be provided for that creasing direction. Note that tuning of the frequency and/or energy level of the wave energy may be necessary to obtain natural frequencies of the rotating cylinder with its raised profile.

In one embodiment, the diecutting station 30 may include steel rotary die rolls to diecut a perimeter outline for the cartons, and lower anvil rolls with stripping pins may be installed to remove waste from the diecutting operation.

Accordingly, in one embodiment, a conditioning method has been disclosed comprising receiving a substrate having a surface to be indented, and applying wave energy and at substantially the same time applying a squeezing pressure along a narrow substantially linear or curvilinear area of the surface of the substrate, wherein the wave energy is sufficient to heat the surface in this narrow substantially linear or curvilinear area to create a reduced thickness therein. In one embodiment, the wave energy is ultrasonic energy. In a further embodiment, the applying wave energy and applying a squeezing pressure steps are performed by moving the surface between a rotatable cylinder having a raised profile with a linear or curvilinear pattern and a contact surface for a wave energy device. In yet a further embodiment, the substrate is a web. In a different embodiment, the substrate is a sheet.

The method could comprise in a further embodiment, controlling at least one of the wave energy applied to the surface of the substrate, a squeezing pressure applied to the substrate, and an angular velocity of the substrate, in response to a parameter. In selected embodiments, the parameter may be a depth of the indentation in the substrate, a substrate material characteristic, a rate of substrate movement, and a width of the indentation in the substrate.

The method could comprise in a further embodiment a step of performing a folding operation as subsequent processing. Alternatively, the method could further include the step of a cutting operation followed by a folding operation as subsequent processing. In a yet further embodiment, the method could comprise a cutting operation as the subsequent processing.

In a yet further embodiment, the apparatus and method could be used to perform an embossing step during a process. This method of embossing is particularly advantageous for certain materials such as plastic.

In yet a further embodiment, the method could be used to selectively cure chemicals printed or otherwise disposed on the substrate, such as for example, conductive inks. For such a curing application, the indentation may, in some embodiments, be very small, i.e., on the order of 0.0001mm.

It should be noted that although the description provided herein shows a specific order of method steps, it is understood that the order of these steps may differ from what is depicted. Also two or more steps may be performed concurrently or with partial concurrence. Such variation will depend on the systems chosen and on designer choice or on the type of job to be processed. It is understood that all such variations are within the scope of the invention.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

What is claimed is:

1. An apparatus for conditioning a substrate for subsequent processing, comprising:
an ultrasonic energy device with an ultrasonic horn having a contact surface;
a rotatable cylinder having a raised profile with a linear or curvilinear pattern, the rotatable cylinder disposed adjacent the horn, but on an opposite side from the substrate;
wherein the substrate is squeezed between the contact surface of the ultrasonic horn and the pattern on the rotatable cylinder to thereby apply heat and pressure during operation of the ultrasonic energy device to create a linear or curvilinear indentation in a surface of the substrate.

2. The apparatus as defined in claim 1, wherein the substrate is a web.

3. The apparatus as defined in claim 1, wherein the substrate is a sheet.

4. The apparatus as defined in claim 1, wherein the substrate is a plastic substrate.

5. The apparatus as defined in claim 1, further comprising a control device to control at least one of ultrasonic energy applied to the surface of the substrate, a squeezing pressure applied to the substrate, and an angular velocity of the substrate, in response to a parameter.

6. The apparatus as defined in claim 5, wherein the parameter is a depth of the indentation in the substrate.

7. The apparatus as defined in claim 5, wherein the parameter is a substrate material characteristic.

8. The apparatus as defined in claim 5, wherein the parameter is a width of the indentation in the substrate.

9. The apparatus as defined in claim 1, further comprising a folding module for performing a folding operation as the subsequent processing.

10. The apparatus as defined in claim 1, further comprising a cutting module and a folding module for performing a cutting operation followed by a folding operation as the subsequent processing.

11. The apparatus as defined in claim 1, further comprising a cutting tool for performing a cutting operation as the subsequent processing

12. The apparatus as defined in claim 1, further comprising a tool for disposing a chemical on at least a portion of the surface of the substrate for changing a parameter of the surface of the substrate.

13. The apparatus as defined in claim 12, wherein the parameter is a coefficient of friction of the surface of the substrate.

14. The apparatus as defined in claim 12, wherein the parameter is a heat absorption characteristic of the substrate.

15. The apparatus as defined in claim 12, wherein the chemical is a conductive ink.

16. The apparatus as defined in claim 1, further comprising:
displacement structure for moving a substrate between said ultrasonic horn and the rotatable cylinder.

17. The apparatus as defined in claim 16, wherein the displacement structure comprises a roller that is driven.

18. The apparatus as defined in claim 16, wherein the displacement structure comprises a drive mechanism for driving the rotatable cylinder.

19. The apparatus as defined in claim 16, wherein the displacement structure displaces the substrate in a direction substantially normal to an axis of rotation of the rotatable cylinder and wherein the raised profile with the linear or curvilinear pattern of the rotatable cylinder is substantially parallel to the axis of rotation of the rotatable cylinder.

20. The apparatus as defined in claim 16, wherein the displacement structure displaces the substrate in a direction substantially normal to an axis of rotation of the rotatable cylinder and wherein the raised profile with the linear or curvilinear pattern of the rotatable cylinder is not substantially parallel to the axis of rotation of the rotatable cylinder.

21. The apparatus as defined in claim 1, wherein the rotatable cylinder is not substantially normal to a direction of movement of the substrate, and wherein the raised profile with the linear or curvilinear pattern of the rotatable cylinder is not substantially parallel to the axis of rotation of the rotatable cylinder.

22. The apparatus as defined in claim 1, wherein the rotatable cylinder is not substantially normal to a direction of movement of the substrate, and wherein the raised profile with the linear or curvilinear pattern of the rotatable cylinder is substantially parallel to the axis of rotation of the rotatable cylinder.

23. The apparatus as defined in claim 1, comprising structure for varying a gap between the raised profile of the rotatable cylinder and the contact surface of the ultrasonic horn.

24. The apparatus as defined in claim 23, further comprising a control device for automatically controlling the gap based on at least one parameter.

25. A conditioning method, comprising:
receiving a substrate having a surface to be indented;
applying wave energy and at substantially the same time applying a squeezing pressure along a narrow substantially linear or curvilinear area of the surface of the substrate, wherein the wave energy is sufficient to heat the surface in this narrow substantially linear or curvilinear area to create a reduced thickness therein.

26. The method as defined in claim 25, wherein the wave energy is ultrasonic energy.

27. The method as defined in claim 25, wherein the applying wave energy and applying a squeezing pressure steps are performed by moving the surface between a rotatable cylinder having a raised profile with a linear or curvilinear pattern and a contact surface for a wave energy device.

28. The method as defined in claim 25, wherein the substrate is a web.

29. The method as defined in claim 25, wherein the substrate is a sheet.

30. The method as defined in claim 25, wherein the substrate is a plastic substrate.

31. The method as defined in claim 25, further comprising a controlling at least one of the wave energy applied to the surface of the substrate, a squeezing pressure applied to the substrate, and an angular velocity of the substrate, in response to a parameter.

32. The method as defined in claim 31, wherein the parameter is a depth of the indentation in the substrate.

33. The method as defined in claim 31, wherein the parameter is a substrate material design characteristic.

34. The method as defined in claim 31, wherein the parameter is a rate of substrate movement.

35. The method as defined in claim 31, wherein the parameter is a width of the indentation in the substrate.

36. The method as defined in claim 25, further comprising performing a folding operation as the subsequent processing.

37. The method as defined in claim 25, further comprising performing a cutting operation followed by a folding operation as the subsequent processing.

38. The method as defined in claim 25, further comprising performing a cutting operation as the subsequent processing

39. The method as defined in claim 24, further comprising disposing a chemical on at least a portion of the surface of the substrate for changing a parameter of the surface of the substrate.

40. The method as defined in claim 39, wherein the parameter is a coefficient of friction of the surface of the substrate.

41. The method as defined in claim 39, wherein the parameter is a heat absorption characteristic of the substrate.

42. The method as defined in claim 25, further comprising changing a speed of translation of the substrate.

43. The method as defined in claim 27, further comprising moving the substrate at a different speed relative to the rotatable cylinder.

44. The method as defined in claim 27, displacing the substrate in a direction substantially normal to an axis of rotation of the rotatable cylinder and wherein the raised profile with the linear or curvilinear pattern of the rotatable cylinder is substantially parallel to the axis of rotation of the rotatable cylinder.

45. The method as defined in claim 27, displacing the substrate in a direction substantially normal to an axis of rotation of the rotatable cylinder and wherein the raised profile with the linear or curvilinear pattern of the rotatable cylinder is not substantially parallel to the axis of rotation of the rotatable cylinder.

46. The method as defined in claim 27, wherein the rotatable cylinder is not substantially normal to a direction of movement of the substrate, and wherein the raised profile with the linear or curvilinear pattern of the rotatable cylinder is not substantially parallel to the axis of rotation of the rotatable cylinder.

47. The method as defined in claim 27, wherein the rotatable cylinder is not substantially normal to a direction of movement of the substrate, and wherein the raised profile with the linear or curvilinear pattern of the rotatable cylinder is substantially parallel to the axis of rotation of the rotatable cylinder.

48. The method as defined in claim 27, comprising varying a gap between the raised profile of the rotatable cylinder and the contact surface of the wave energy device.

49. The method as defined in claim 48, further comprising a processor for automatically controlling the gap based on at least one parameter.

50. The method as defined in claim 27, comprising varying a height of the raised profile of the rotatable cylinder by changing to a different rotatable cylinder with a different height for its raised profile.

51. The method as defined in claim 27, further comprising: varying a width of the raised profile of the rotatable cylinder by changing to a different rotatable cylinder with a different width for its raised profile.

52. A cassette, comprising:
a support frame;
within the support frame, structure for supporting a substrate path for receiving a substrate of material;
an ultrasonic horn;
a rotatable cylinder having a raised profile with a linear or curvilinear pattern, the rotatable cylinder disposed adjacent the ultrasonic horn;
wherein the substrate is squeezed between the contact surface of the ultrasonic horn and the pattern on the rotatable cylinder to thereby apply heat and pressure to create a linear or curvilinear indentation in a surface of the substrate.

53. The cassette as defined in claim 52, further comprising a cutting tool.

54. A carton creation method, comprising:
receiving a web having a surface to be indented;
applying wave energy and at substantially the same time applying a squeezing pressure along a narrow substantially linear or curvilinear area of the surface of the web, wherein the wave energy is sufficient to heat the surface in this narrow substantially linear or curvilinear area to create a reduced thickness therein; and
cutting the web.

55. The method as defined in claim 52, wherein the web is a plastic web, and further comprising:
folding the web along the reduced thickness in the surface.

56. An in-line press, comprising:
a printing station;
an indenting station comprising a support frame, within the support frame structure for supporting a substrate path for receiving a substrate, a wave energy generator with a wave energy applicator for generating and applying wave energy to the substrate, a rotatable cylinder having a raised profile with a linear or curvilinear pattern, the rotable cylinder disposed on an opposite side of the substrate path from the wave energy applicator and substantially directly opposite to the wave energy applicator, and;
a rotary diecutting station.

57. The in-line press as defined in claim 56, further comprising a folding apparatus following the diecutting station.
